(19) United States
(12) Patent Application Publication
(10) Pub. No.: US 2024/0188552 A1
(43) Pub. Date: Jun. 13, 2024

(54) SYSTEM AND METHOD FOR AN AGRICULTURAL APPLICATOR

(71) Applicant: CNH Industrial America LLC, New Holland, PA (US)

(72) Inventor: Kevin M. Smith, Narvon, PA (US)

(21) Appl. No.: 18/076,878

(22) Filed: Dec. 7, 2022

(51) Int. Cl. A01M 7/00; B05B 12/08; B05B 12/12; B05B 15/68

(52) U.S. Cl. CPC A01M 7/0089; B05B 12/085; B05B 12/122; B05B 15/68

(57) ABSTRACT

An agricultural system can include a product application system including one or more nozzle assemblies an actuator configured to move the one or more nozzle assemblies between a first position and a second position. A target sensor can be configured to capture data indicative of one or more features within a field. A computing system can be communicatively coupled to the product application system and the target sensor. The computing system can be configured to identify a target within the field based on the data from the target sensor, determine a nozzle activation time defined by a period between capturing of the data from the target sensor and a nozzle spray fan aligning with the target, and activate the actuator to move the one or more nozzle assemblies between the first position and the second position based on the nozzle activation time deviating from a defined nozzle time range.

### FIELD

The present disclosure generally relates to agricultural implements and, more particularly, to systems and methods for monitoring a spray operation, such as by monitoring and/or altering a flow condition of an agricultural product during the spray operation.

### BACKGROUND

Various types of work vehicles utilize applicators (e.g., sprayers, floaters, etc.) to deliver an agricultural product to a ground surface of a field. The agricultural product may be in the form of a solution or mixture, with a carrier (such as water) being mixed with one or more active ingredients (such as an herbicide, agricultural product, fungicide, a pesticide, or another product).

The applicators may be pulled as an implement or self-propelled and can include a tank, a pump, a boom assembly, and a plurality of nozzles carried by the boom assembly at spaced locations. The boom assembly can include a pair of boom arms, with each boom arm extending to either side of the applicator when in an unfolded state. Each boom arm may include multiple boom sections, each with a number of spray nozzles (also sometimes referred to as spray tips).

The spray nozzles on the boom assembly disperse the agricultural product carried by the applicator onto a field. During a spray operation, however, various factors may affect a quality of the application of the agricultural product to the field. Accordingly, an improved system and method for monitoring the quality of application of the agricultural product to the field would be welcomed in the technology.

### BRIEF DESCRIPTION

Aspects and advantages of the technology will be set forth in part in the following description, or may be obvious from the description, or may be learned through practice of the technology.

In some aspects, the present subject matter is directed to an agricultural system comprising a product application system comprising one or more nozzle assemblies and an actuator configured to move the one or more nozzle assemblies between a first position and a second position. A target sensor is configured to capture data indicative of one or more features within a field. A computing system is communicatively coupled to the product application system and the target sensor. The computing system is configured to identify a target within the field based on the data from the target sensor, determine a nozzle activation time defined by a period between capturing of the data from the target sensor and a nozzle spray fan aligning with the target, and activate the actuator to move the one or more nozzle assemblies between the first position and the second position based on the nozzle activation time deviating from a defined nozzle time range.

In some aspects, the present subject matter is directed to a method for an agricultural application operation. The method includes receiving, from a target sensor, data indicative of one or more features within a field. The method also includes identifying, with a computing a system, a target within the field based on the one or more features. The method further includes determining, a nozzle activation time defined by a period between capturing of the data from the target sensor and a nozzle spray fan aligning with the target. Lastly, the method includes activating an actuator to rotate one or more nozzle assemblies between a first position and a second position about an axis of rotation based on the nozzle activation time deviating from a defined nozzle time range.

In some aspects, the present subject matter is directed to an agricultural system comprising a product application system comprising one or more nozzle assemblies and an actuator configured to move the one or more nozzle assemblies between a first position and a second position. A sensing system is configured to capture data indicative of one or more spray conditions. A target sensor is configured to capture data indicative of one or more features within a field. A computing system is communicatively coupled to the product application system, the target sensor, and the sensing system. The computing system is configured to identify a target within the field based on the data from the target sensor, and determine a nozzle activation time defined by a period between the capturing of the data from the target sensor and a nozzle spray fan aligning with the target based on the data from the sensing system.

These and other features, aspects, and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a perspective view of an agricultural work vehicle in accordance with aspects of the present subject matter:

FIG. 2 illustrates a side view of the work vehicle in accordance with aspects of the present subject matter:

FIG. 3 is a rear partial view of a boom arm of the vehicle in accordance with aspects of the present subject matter:

FIG. 4 is a perspective view of a nozzle assembly positioned along the boom arm in accordance with aspects of the present subject matter:

FIG. 5 illustrates a block diagram of components of the agricultural applicator system in accordance with aspects of the present subject matter:

FIG. 6 is a cross-sectional view of the boom arm and product application system taken along the line VI-VI of FIG. 3:

FIG. 7 is a cross-sectional view of the boom arm and product application system taken along the line VI-VI of FIG. 3: and

FIG. 8 illustrates a flow diagram of a method for an agricultural application operation in accordance with aspects of the present subject matter.

Repeat use of reference characters in the present specification and drawings is intended to represent the same or analogous features or elements of the present technology.

### DETAILED DESCRIPTION

Reference now will be made in detail to embodiments of the disclosure, one or more examples of which are illustrated in the drawings. Each example is provided by way of explanation of the discourse, not limitation of the disclosure. In fact, it will be apparent to those skilled in the art that various modifications and variations can be made in the present disclosure without departing from the scope or spirit of the disclosure. For instance, features illustrated or described as part can be used with another embodiment to yield a still further embodiment. Thus, it is intended that the present disclosure covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to an agricultural product within a fluid circuit. For example, “upstream” refers to the direction from which an agricultural product flows, and “downstream” refers to the direction to which the agricultural product moves. The term “selectively” refers to a component's ability to operate in various states (e.g., an ON state and an OFF state) based on manual and/or automatic control of the component.

Furthermore, any arrangement of components to achieve the same functionality is effectively “associated” such that the functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone: B alone: C alone: A and B in combination; A and C in combination: B and C in combination; or A, B, and C in combination.

In general, the present subject matter is directed to an agricultural system that includes a product application system. The product application system can include one or more nozzle assemblies and an actuator configured to move the one or more nozzle assemblies between a first position and a second position.

A sensing system can be configured to capture data indicative of one or more spray conditions. During a spray operation, various spray conditions may affect a spray quality of application of the agricultural product. To monitor such spray conditions, a sensing system may include one or more condition sensors, a weather station, and/or any other assembly, which may be installed on the vehicle and/or the boom assembly. In general, the sensing system may be configured to capture data indicative of one or more spray conditions associated with the fans of the agricultural product being dispensed by the nozzle assemblies. The spray conditions may, in turn, be indicative of the quality of the spray operation, such as whether the agricultural product is directed to the defined target.

A target sensor can be configured to capture data indicative of one or more features within a field. The target sensor may be configured to capture data indicative of various features within a field. In several embodiments, the target sensor may be installed or otherwise positioned on one or more boom sections of the boom assembly and/or any other practicable location about the vehicle.

A computing system can be communicatively coupled to the product application system, the target sensor, and the sensing system. The computing system can be configured to identify a target within the field based on the data from the target sensor and determine a nozzle activation time defined by a period between the capturing of the data from the target sensor and a nozzle spray fan aligning with the target based on the data from the sensing system. The one or more nozzle assemblies when the target is within a spray fan of the one or more nozzle assemblies, which may include the detected/identified weeds (e.g., with a suitable herbicide) and/or the detected/identified crops (e.g., with a nutrient). In some instances, the nozzle activation time can be at least partially based on a processing time of the computing system.

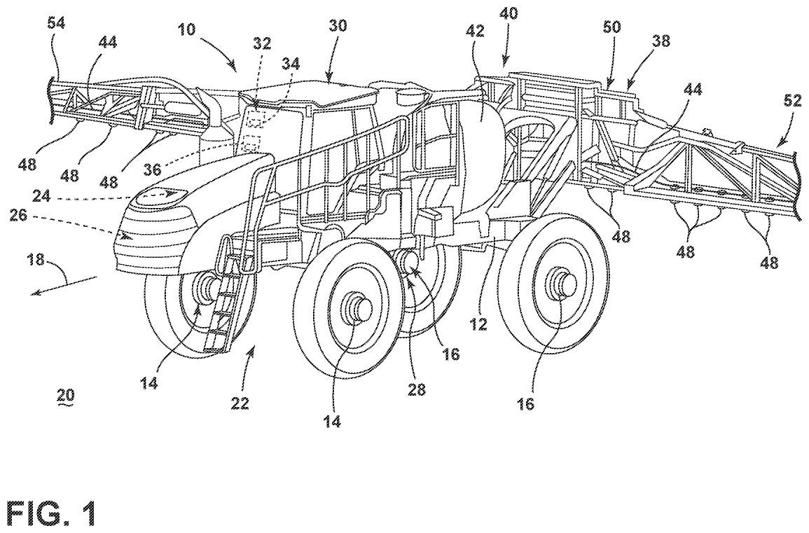

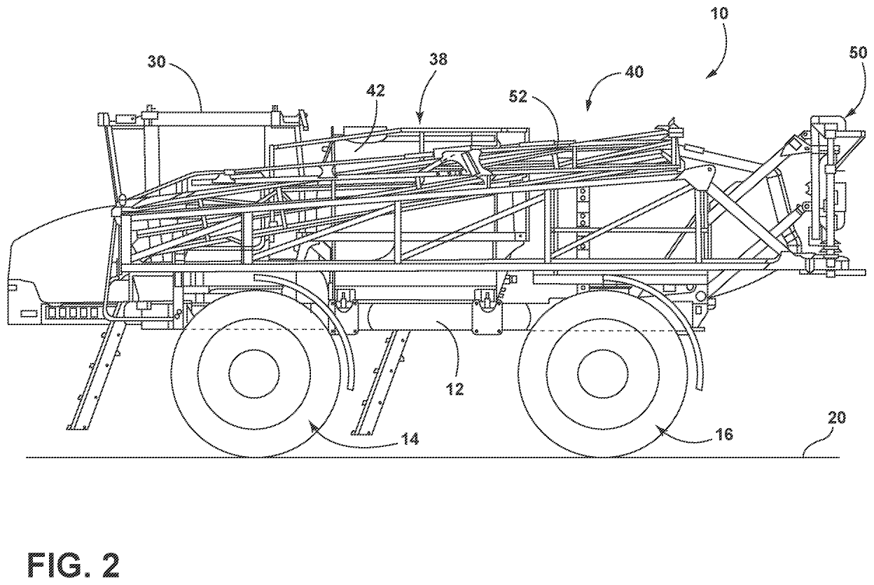

Referring now to FIGS. 1 and 2, a work vehicle 10 is generally illustrated as a self-propelled agricultural applicator. However, in alternate embodiments, the work vehicle 10 may be configured as any other suitable type of work vehicle 10 configured to perform agricultural application operations, such as a tractor or other vehicle configured to haul or tow an application implement.

In various embodiments, the work vehicle 10 may include a chassis 12 configured to support or couple to a plurality of components. For example, front and rear wheels 14, 16 may be coupled to the chassis 12. The wheels 14, 16 may be configured to support the work vehicle 10 relative to a field 20 and move the work vehicle 10 in a direction of travel (e.g., as indicated by arrow 18 in FIG. 1) across the field 20. In this regard, the work vehicle 10 may include a powertrain control system 22 that includes a power plant 24, such as an engine, a motor, or a hybrid engine-motor combination, a hydraulic propel or transmission system 26 configured to transmit power from the engine to the wheels 14, 16, and/or a brake system 28.

The chassis 12 may also support a cab 30, or any other form of user's station, for permitting the user to control the operation of the work vehicle 10. For instance, as shown in FIG. 1, the work vehicle 10 may include a user interface 32 having a display 34 for providing messages and/or alerts to the user and/or for allowing the user to interface with the vehicle's controller through one or more user input devices 36 (e.g., levers, pedals, control panels, buttons, and/or the like).

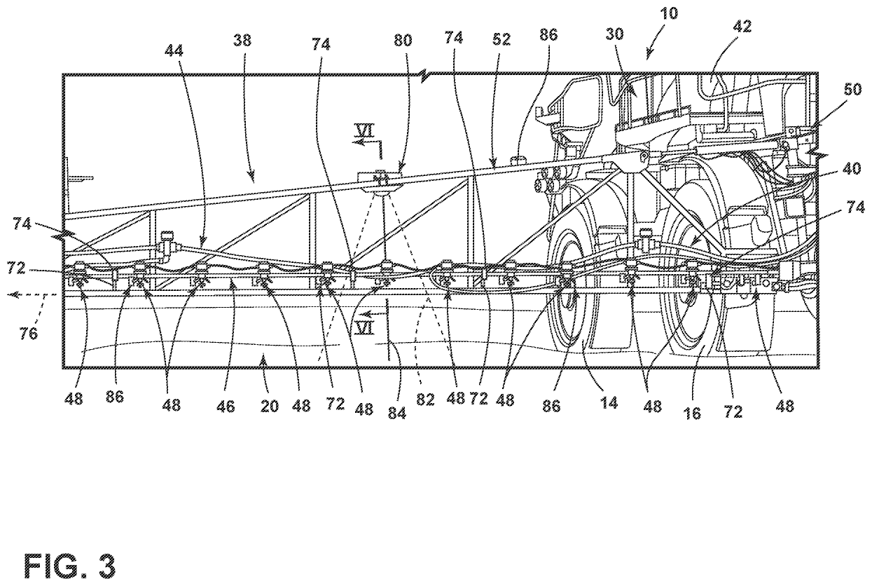

The chassis 12 may also support a boom assembly 38 mounted to the chassis 12. In addition, the chassis 12 may support a product application system 40 that includes one or more tanks 42, such as a rinse tank and/or a product tank. The product tank may be generally configured to store or hold an agricultural product, such as a pesticide, a fungicide, a rodenticide, a nutrient, and/or the like. The agricultural product is conveyed from the product tank through plumbing components, such as interconnected pieces of conduit 44 and/or one or more headers 46 (FIG. 3), for release onto the underlying field 20 (e.g., plants and/or soil) through one or more nozzle assemblies 48.

As shown in FIGS. 1 and 2, the boom assembly 38 can include a frame 50 that supports first and second boom arms 52, 54, which may be orientated in a cantilevered nature. The first and second boom arms 52, 54 are generally movable between an operative or unfolded position (FIG. 1) and an inoperative or folded position (FIG. 2). When distributing the product, the first and/or second boom arm 52, 54 extends laterally outward from the work vehicle 10 to cover swaths of the underlying field 20, as illustrated in FIG. 1. However, to facilitate transport, each boom arm 52, 54 of the boom assembly 38 may be independently folded forwardly or rearwardly into the inoperative position, thereby reducing the overall width of the vehicle 10, or in some examples, the overall width of a towable implement when the applicator is configured to be towed behind the work vehicle 10.

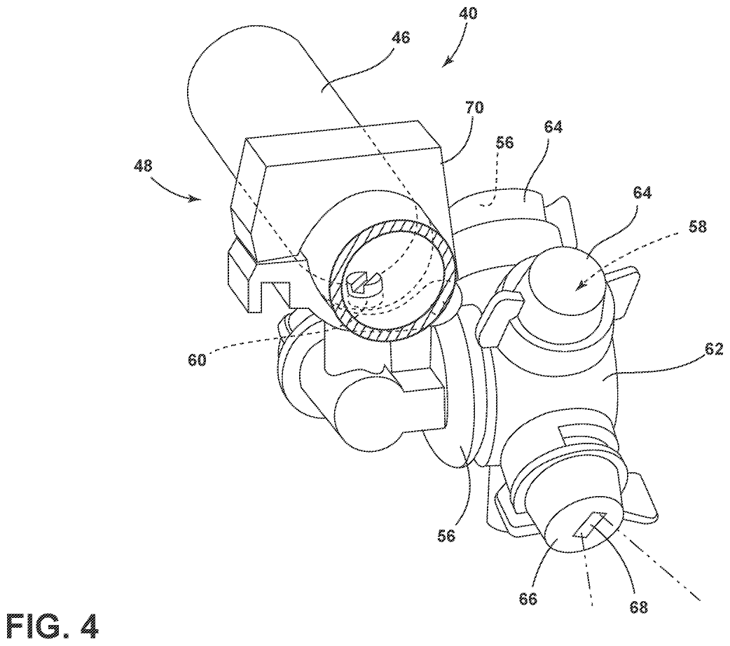

Referring to FIGS. 3 and 4, the boom assembly 38 may be configured to support a plurality of nozzle assemblies 48. Each nozzle assembly 48 may be configured to dispense an agricultural product stored within the tank 42 (FIG. 1) onto the underlying field 20. In several embodiments, fluid conduits 44 and/or headers 46 may fluidly couple the nozzle assemblies 48 to the tank 42. In this respect, as the work vehicle 10 travels across the field 20 in the direction of travel 18 to perform a spray operation thereon, the agricultural product moves from the tank 42 through the fluid conduits 44 and/or headers 46 to each of the nozzle assemblies 48. The nozzle assemblies 48 may, in turn, dispense or otherwise spray a fan of the agricultural product onto the underlying field 20.

In some examples, such as the one illustrated in FIG. 3, one or more nozzle assemblies 48 may be operably coupled with headers 46. In such examples, each of the nozzle assemblies 48 within a header 46 may receive a common agricultural product from the conduit. In some cases, each header 46 may be generally rigid thereby supporting the nozzle assemblies 48 operably coupled with that respective header 46.

With further reference to FIGS. 3 and 4, each nozzle assembly 48, according to various examples, can include a nozzle body 56 fluidly interconnected between multiple fluid outlet ports 58 and a single fluid inlet port 60. The outlet ports 58 are circumferentially spaced about a manifold 62, which allows fluid to be dispensed from the nozzle assembly 48 at various angular positions for the particulars of a given application. In this regard, all but one of the ports may be closed by a cap 64 while one of the ports will be fitted with an orifice cap 66. The orifice cap 66 can include a spray nozzle 68. The orifice cap 66 threads onto the outlet port 58 and can be replaced by other orifice caps having differently configured spray nozzles to allow an operator flexibility in how fluid is applied, such as droplet size, spray pattern, spray width, etc. The nozzle assembly 48 can use a clamp 70 for coupling the nozzle assembly 48 to the header 46. It is understood that other types of coupling devices may be used to fluidly connect the nozzle assembly 48 to the distribution manifold. Also, while a five-way nozzle assembly 48 is shown, it is understood that the invention is applicable to other types of spray nozzle assemblies 48.

With further reference to FIG. 3, in various examples, each of the headers 46 may be operably coupled with the boom assembly 38 through one or more supports 72. Moreover, each of the headers 46 may be operably coupled with the boom assembly 38 through one or more actuators 74. In various examples, the actuators 74 may be configured to rotate one or more nozzle assemblies 48 about an axis of rotation 76 (e.g., a lateral axis). In some cases, an actuator 74 may be respectively coupled with each nozzle assembly 48 such that each nozzle assembly 48 may rotate independently of any other nozzle assembly 48. Additionally or alternatively, an actuator 74 may be operably coupled with each header 46 such that each header 46 may be rotated thereby rotating each nozzle assembly 48 coupled to the header 46. In various examples, the actuators 74 may be configured as an electric actuator, a hydraulic actuator, a pneumatic actuator, and/or any other practicable type of actuator.

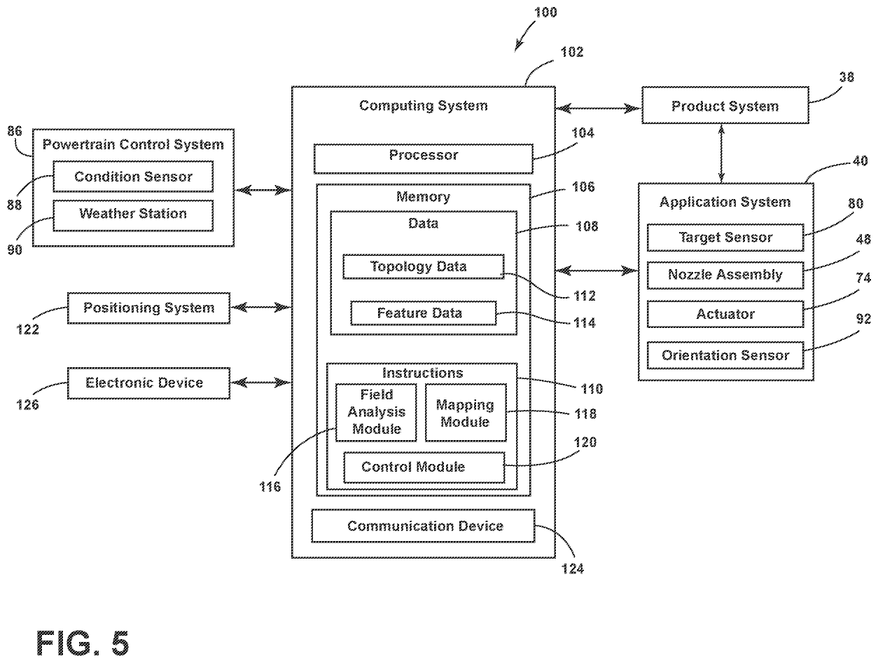

Referring further to FIG. 3, the boom assembly 38 may further include one or more target sensors 80 configured to capture data indicative of various features within the field 20. In several embodiments, the target sensors 80 may be installed or otherwise positioned on one or more boom arms 52, 54 of the boom assembly 38. Furthermore, each target sensor 80 may have a field of view or detection zone 82 (e.g., as indicated by dashed lines in FIG. 3) that is generally defined by a focal axis 84. In this regard, each target sensor 80 may be able to capture data indicative of objects and/or field conditions within its detection zone 82. For instance, in some embodiments, the target sensors 80 are feature detecting/identifying imaging devices, where the data captured by the target sensors 80 may be indicative of the location and/or type of plants and/or other objects within the field 20. More particularly, in some embodiments, the data captured by the target sensors 80 may be used to allow various objects to be detected. For example, the data captured may allow a computing system 102 (FIG. 5) to distinguish weeds from useful plants within the field 20 (e.g., crops). In such instances, the target sensor data may, for instance, be used within a spraying operation to selectively spray or treat a defined target, which may include the detected/identified weeds (e.g., with a suitable herbicide) and/or the detected/identified crops (e.g., with a nutrient). In addition, the data captured may allow a computing system 102 to identify one or more landmarks. In various embodiments, the landmarks may include a tree, a tree line, a building, a tower, and/or the like that may be proximate and/or within the field 20.

It should be appreciated that the agricultural sprayer 10 may include any suitable number of target sensors 80 and should not be construed as being limited to the number of target sensors 80 shown in FIG. 3. Additionally, it should be appreciated that the target sensors 80 may generally correspond to any suitable sensing devices. For example, each target sensor 80 may correspond to any suitable camera, such as single-spectrum camera or a multi-spectrum camera configured to capture images, for example, in the visible light range and/or infrared spectral range. Additionally, in various embodiments, the cameras may correspond to a single lens camera configured to capture two-dimensional images or a stereo cameras having two or more lenses with a separate image imaging device for each lens to allow the cameras to capture stereographic or three-dimensional images. Alternatively, the target sensors 80 may correspond to any other suitable image capture devices and/or other imaging devices capable of capturing “images” or other image-like data of the field 20. For example, the target sensors 80 may correspond to or include radio detection and ranging (RADAR) sensors, light detection and ranging (LIDAR) sensors, and/or any other practicable device.

With further reference to FIG. 3, during a spray operation, various spray conditions may affect a spray quality of the application of the agricultural product. In several embodiments, the one or more spray conditions that may affect the spray conditions can include at least one of an airflow at each nozzle assembly 48, a nozzle tip size and style, which agricultural product is being applied, an agricultural product application rate, a target location, weather conditions, an agricultural product pressure, boom assembly movement (e.g., jounce), a vehicle speed, a vehicle acceleration/deceleration, a turning direction/angle/speed, and/or any other variable. Based on the spray conditions, the product application system 40 may rotate each nozzle assembly 48 to a defined position to allow for the accurate application of the agricultural product to the target, all of which may be detected by a sensing system 86 that can include one or more condition sensors 88 (FIG. 5) and/or a weather station 90 (FIG. 5). For instance, as vehicle speed increases, the nozzle assembly 48 orientation can move rearward so that more reaction time is allowed between sensing a target and opening a control valve within the nozzle assembly 48.

Referring now to FIG. 5, a schematic view of a system 100 for operating the vehicle 10 is illustrated in accordance with aspects of the present subject matter. In general, the system 100 will be described with reference to the vehicle 10 described above with reference to FIGS. 1-4. However, it should be appreciated by those of ordinary skill in the art that the disclosed system 100 may generally be utilized with agricultural machines having any other suitable machine configuration. Additionally, it should be appreciated that, for purposes of illustration, communicative links, or electrical couplings of the system 100 shown in FIG. 5 are indicated by arrows.

As shown in FIG. 5, the system 100 may include a computing system 102 operably coupled with the product application system 40. As provided herein, the product application system 40 can include a target sensor 80, one or more nozzle assemblies 48, one or more actuators 74, and/or an orientation sensor 92. In operation, the computing system 102 may identify a target based on data generated by the target sensor 80. In addition, the computing system 102 may receive data indicative of one or more spray conditions that may affect a spray quality of application of the agricultural product. Based on the location of the target and the one or more spray conditions, the computing system 102 may determine a nozzle activation time defined by a period between the capturing of the data and a nozzle spray fan aligning with the target. Additionally, the computing system 102 may activate the actuator 74 to move the one or more nozzle assemblies 48 between the first position and the second position based on the nozzle activation time deviating from a defined nozzle time range. In some examples, the computing system 102 may be configured to limit the actuator 74 to rotate the one or more nozzle assemblies 48 within a rotational range. The rotational range may be an angular limit about the axis of rotation 76 of rotation of the nozzle assemblies 48 relative to a vertical axis 124 in both a direction vehicle forward of the vertical axis 124 and vehicle rearward of the vertical axis 124. In some examples, the rotational range may be at least partially based on a height of the nozzle assembly 48 relative to the field 20.

In general, the computing system 102 may comprise any suitable processor-based device, such as a computing device or any suitable combination of computing devices. Thus, in several embodiments, the computing system 102 may include one or more processors 104 and associated memory 106 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory 106 of the computing system 102 may generally comprise memory elements including, but not limited to, a computer readable medium (e.g., random access memory (RAM)), a computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory 106 may generally be configured to store information accessible to the processor 104, including data 108 that can be retrieved, manipulated, created, and/or stored by the processor 104 and instructions 110 that can be executed by the processor 104, when implemented by the processor 104, configure the computing system 102 to perform various computer-implemented functions, such as one or more aspects of the image processing algorithms and/or related methods described herein. In addition, the computing system 102 may also include various other suitable components, such as a communications circuit or module, one or more input/output channels, a data/control bus, and/or the like.

In various embodiments, the computing system 102 may correspond to an existing controller of the agricultural vehicle 10, or the computing system 102 may correspond to a separate processing device. For instance, in some embodiments, the computing system 102 may form all or part of a separate plug-in module or computing device that is installed relative to the vehicle 10 or the boom assembly 38 to allow for the disclosed system 100 and method to be implemented without requiring additional software to be uploaded onto existing control devices of the vehicle 10 or the boom assembly 38. Further, the various functions of the computing system 102 may be performed by a single processor-based device or may be distributed across any number of processor-based devices, in which instance such devices may be considered to form part of the computing system 102. For instance, the functions of the computing system 102 may be distributed across multiple application-specific controllers.

In various embodiments, the memory device(s) 106 of the computing system 102 may include one or more databases for storing information. For instance, as shown in FIG. 5, the memory device(s) 106 may include a topology database 112 storing data received from the one or more target sensors 80. For instance, topology data may be captured while the field 20 is in a pre-emergence condition (e.g., prior to a seed planting operation in the field 20 or following such operation but prior to the emergence of the plants).

Additionally or alternatively, the memory device(s) 106 may include a feature database 114 storing image data associated with the field 20. For instance, the image data may be raw or processed data of one or more portions of the field 20. The feature database 114 may also store various forms of data that a related to the identified objects within and/or proximate to the field 20. For example, the objects may include targets and/or landmarks that may be used to relocate the targets during a subsequent operation.

Referring still to FIG. 5, in several embodiments, the instructions stored within the memory device(s) 106 of the computing system 102 may be executed by the processor(s) 104 to implement a field analysis module 116. In general, the field analysis module 116 may be configured to analyze the feature data from the one or more target sensors 80 to allow the computing system 102 to identify one or more objects, such as a target and/or a landmark, within the field 20. For instance, in several embodiments, the field analysis module 116 may be configured to analyze/process the data to detect/identify the type of various objects in the field 20. In this regard, the computing system 102 may include any suitable image processing algorithms stored within its memory 106 or may otherwise use any suitable image processing techniques to determine, for example, the presence of a target within the field 20 based on the feature data. For instance, in some embodiments, the computing system 102 may be able to distinguish between weeds and emerging/standing crops. Additionally or alternatively, in some embodiments, the computing system 102 may be configured to distinguish between weeds and emerging/standing crops, such as by identifying crop rows of emerging/standing crops and then inferring that plants positioned between adjacent crop rows are weeds.

Additionally or alternatively, the field analysis module 116 may be configured to analyze the topology data to create a topology map. In some instances, the field analysis module 116 may also predict a deflection model of the boom assembly 38 at various locations within the field 20 based on the topology. For instance, the topology map may identify one or more terrain variations that may cause the boom assembly 38 to deflect while in use.

Moreover, the instructions stored within the memory device(s) 106 of the computing system 102 may be executed by the processor(s) 104 to implement a mapping module 118 that is configured to generate one or more maps of the field 20 based on the feature data and/or the topology data. It should be appreciated that, as used herein, a “map” may generally correspond to any suitable dataset that correlates data to various locations within a field 20. Thus, for example, a map may simply correspond to a data table that correlates field contour or topology data to various locations within the field 20 or may correspond to a more complex data structure, such as a geospatial numerical model that can be used to identify various objects in the feature data and/or topology data and determine a position of each object within the field 20, which may, for instance, then be used to generate a graphically displayed map or visual indicator.

In various examples, the computing system 102 may implement machine learning engine methods and algorithms that utilize one or several machine learning techniques including, for example, decision tree learning, including, for example, random forest or conditional inference trees methods, neural networks, support vector machines, clustering, and Bayesian networks. These algorithms can include computer-executable code that can be retrieved by the computing system 102 and may be used to generate a predictive evaluation of the field 20 within the field analysis module 116 and/or the mapping module 118. In some instances, the machine learning engine may allow for changes to the field analysis module 116 and/or the mapping module 118 to be updated without human intervention.

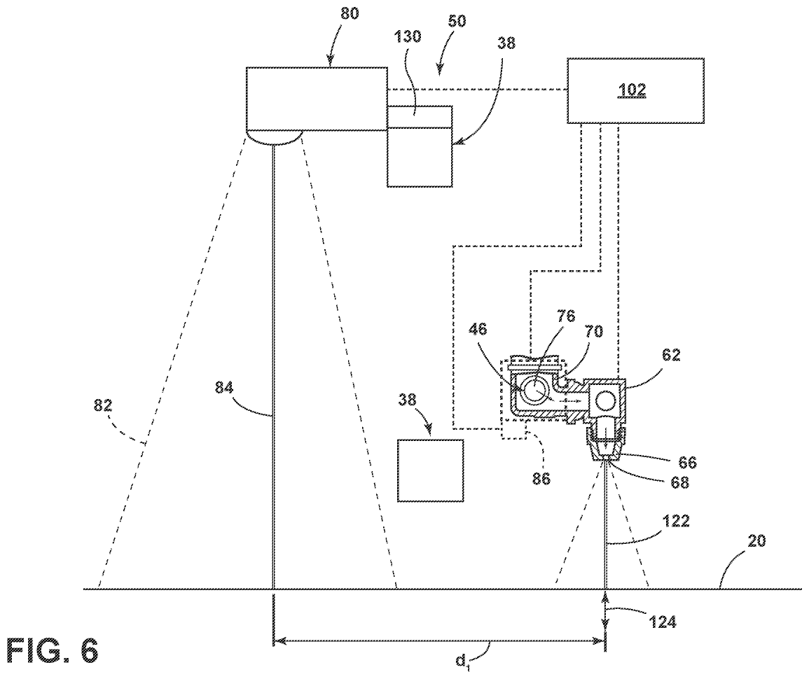

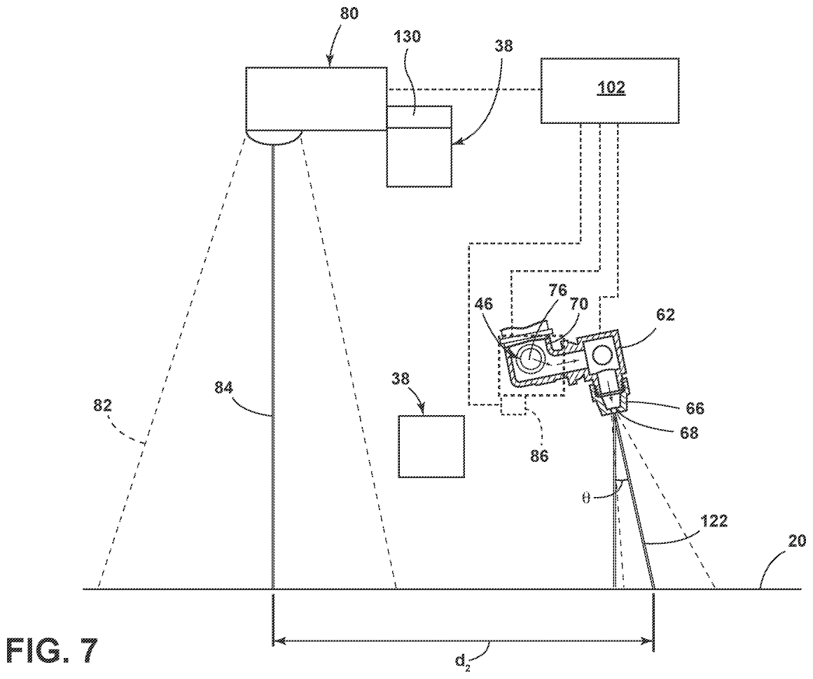

Referring still to FIG. 5, in some embodiments, the instructions 216 stored within the memory 212 of the computing system 102 may also be executed by the processor(s) 104 to implement a control module 120. In general, the control module 120 may be configured to electronically control the operation of one or more components of the product application system 40. For instance, the computing system 102 may identify a target based on data generated by the target sensor 80. In addition, the computing system 102 may receive data indicative of one or more spray conditions that may affect a spray quality of application of the agricultural product. Based on the location of the target and the one or more spray conditions, the computing system 102 may activate the one or more actuators 74 to alter a spray axis 122 (FIGS. 6 and 7) of one or more nozzle assemblies 48 by a target angle θ from a vertical axis 124 (FIGS. 6 and 7). In various examples, one or more orientation sensors 92 may be operably coupled with the computing system 102 and configured to generate data indicative of a position of the one or more nozzle assemblies 48 relative to the vertical axis 124. As such, the computing system 102 may be capable of aligning each nozzle assembly 48 to the target angle θ between sequential iterative rotations. In some examples, the orientation sensor 92 may be configured to generate data indicative of a body's specific force, angular rate, and/or magnetic field surrounding the body, using any combination of accelerometers, gyroscopes, magnetometers, and/or any other practicable device.

In some instances, the computing system 102 may be communicatively coupled to a positioning system 122 that is configured to determine the location of the vehicle 10 by using a GPS system, a Galileo positioning system, the Global Navigation satellite system (GLONASS), the BeiDou Satellite Navigation and Positioning system, a dead reckoning system, and/or the like. In such embodiments, the location determined by the positioning system 122 may be transmitted to the computing system 102 (e.g., in the form of location coordinates) and subsequently stored within a suitable database for subsequent processing and/or analysis.

Further, as shown in FIG. 5, the computing system 102 may also include a communications device(s) 164 to allow for the computing system 102 to communicate with an application system 40. For instance, one or more communicative links or interfaces (e.g., one or more data buses) may be provided between the communications device(s) 164 and the application system 40.

In several embodiments, the computing system 102 may be further configured to communicate via wired and/or wireless communication with one or more remote electronic devices 126 through a communications device 124 (e.g., a transceiver). The network may be one or more of various wired or wireless communication mechanisms, including any combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary wireless communication networks include a wireless transceiver (e.g., a BLUETOOTH module, a ZIGBEE transceiver, a Wi-Fi transceiver, an IrDA transceiver, an RFID transceiver, etc.), local area networks (LAN), and/or wide area networks (WAN), including the Internet, providing data communication services. The electronic device 126 may include a display for displaying information to a user. For instance, the electronic device 126 may display one or more user interfaces and may be capable of receiving remote user inputs associated with adjusting operating variables or thresholds associated with the vehicle 10. In addition, the electronic device 126 may provide feedback information, such as visual, audible, and tactile alerts, and/or allow the operator to alter or adjust one or more components, features, systems, and/or sub-systems of the vehicle 10 through the usage of the remote electronic device 126. It will be appreciated that the electronic device 126 may be any one of a variety of computing devices and may include a processor and memory. For example, the electronic device 126 may be a cell phone, mobile communication device, key fob, wearable device (e.g., fitness band, watch, glasses, jewelry, wallet), apparel (e.g., a tee shirt, gloves, shoes, or other accessories), personal digital assistant, headphones and/or other devices that include capabilities for wireless communications and/or any wired communications protocols. Additionally or alternatively, the electronic device 126 may be configured as a rate control module (RCM) and/or any other module that may be implemented within the product application system 40 and/or any other system or component of the vehicle 10.

With reference to FIGS. 5-7, the target sensors 80 may be installed or otherwise positioned on one or more boom sections of the boom assembly 38, such as by coupling the target sensor 80 to the boom assembly 38 through one or more brackets 130. In operation, each target sensor 80 may have a field of view or detection zone 82 (e.g., as indicated by dashed lines) that is generally defined by a focal axis 84. In this regard, each target sensor 80 may be able to capture data indicative of objects and/or field conditions within its detection zone 82. For instance, in some embodiments, the target sensors 80 are feature detecting/identifying imaging devices, where the data captured by the target sensors 80 may be indicative of the location and/or type of plants and/or other objects within the field 20.

In addition, the boom assembly 38 may be configured to support a plurality of nozzle assemblies 48. Each nozzle assembly 48 may be configured to dispense an agricultural product stored within the tank 42 (FIG. 1) onto the underlying field 20. In this respect, as the work vehicle 10 travels across the field 20 in the direction of travel 18 to perform a spray operation thereon, the nozzle assemblies 48 may dispense or otherwise spray a fan of the agricultural product onto one or more targets within the underlying field 20.

During a spray operation, various spray conditions may affect a spray quality of application of the agricultural product. To monitor such spray conditions, a sensing system 86 may include one or more condition sensors 88 (FIG. 5), a weather station 90 (FIG. 5), and/or any other assembly, which may be installed on the vehicle 10 and/or the boom assembly 38. In general, the sensing system 86 may be configured to capture data indicative of one or more spray conditions associated with the fans of the agricultural product being dispensed by the nozzle assemblies 48. The spray conditions may, in turn, be indicative of the quality of the spray operation, such as whether the agricultural product is directed to the defined target. The condition sensors 88 may include position sensors, flow sensors, motion sensors (e.g., accelerometers, gyroscopes, etc.), image sensors (e.g., cameras, LIDAR devices, etc.), radar sensors, ultrasonic sensors, and/or any other practicable sensor, depending on the operating conditions/parameters being monitored. In addition, the weather station 90 may be configured to capture data indicative of a wind speed and direction at a defined position on the work vehicle 10. The mobile weather station 90 can contain any sensor that may be found on a stationary weather station 90 that monitors one or more weather criteria, such as temperature, wind speed, wind direction, relative humidity, barometric pressure, cloud cover, and trends thereof. Based on the spray conditions, the computing system 102 may activate one or more actuators 74 to rotate the nozzle assembly 48 to a defined position to allow for the accurate application of the agricultural product to the target. For instance, in some cases, each of the spray conditions may be compared to a defined condition range.

When each of the spray conditions is within its defined condition range, as illustrated in FIG. 6, the actuator 74 may move the nozzle assembly 48 to a first position such that the spray axis 122 is oriented towards the field 20 at a first angle θ. In some cases, the first position may be a default position with the first angle θ being generally perpendicular to the field 20 and/or the target below the nozzle assembly 48. In such cases, a nozzle activation time defined by a period between the capturing of the data from the target sensor 80 and a nozzle spray fan aligning with the target may be within a defined nozzle time range. In various examples, the defined nozzle time range may be determined based on one or more inputs, one or more spray conditions, a position of the one or more nozzle assemblies 48, and/or a processing time between the computing system 102 identifying a target and the spray axis 122 of the nozzle aligning with the target when in the default position.

If one or more of the spray conditions deviates from its defined condition range, as illustrated in FIG. 7, the computing system 102 may activate the one or more actuators 74 to move the nozzle assembly 48 to a second position such that the spray axis 122 is oriented towards the field 20 and/or the target at a second angle θ. As provided herein, the second angle θ may be offset from the first angle θ relative to an axis of rotation 76. In some cases, a focal axis 84 of the target sensor 80 can be separated from a spray axis 122 of the one or more nozzle assemblies 48 by a first distance d1 when in the first position and by a second distance d2 in the second position. In various examples, the second distance d2 may be greater than the first distance d1 or less than the first distance d1.

In various cases, the deviation of the one or more spray conditions for its respective range may alter a nozzle activation time when the nozzle activation time deviates from the defined nozzle time range. In such instances, the computing system 102 can activate the actuator 74 to move the one or more nozzle assemblies 48 between the first position and the second position thereby altering a processing time between the computing system 102 identifying a target and the spray axis 122 of the nozzle aligning with the target when in the default position. As such, the rotation of the nozzle assembly 48 may allow for the application of the agricultural product to the target while one or more spray conditions is deviating from a generally normal condition. For instance, as vehicle speed increases, the nozzle assembly 48 can rotate such that the spray axis 122 is moved rearward of the default position so that more reaction time is allowed between sensing a weed or other target and dispensing the agricultural product.

In various examples, the computing system 102 may be configured to process/analyze the received data to determine or estimate any movements of the one or more nozzle assemblies 48. For instance, the computing system 102 may include a look-up table(s), suitable mathematical formula, and/or algorithms stored within its memory device 104 that correlate the received sensing system data to a defined position.

In some examples, as the nozzle assembly 48 may be configured to intermittently dispense an agricultural product (e.g., spot spray), the product flow and droplet size may be greater than in broadcast spraying, as the product is applied at specific locations, which can reduce the risk of spray drift and allow for the nozzle assembly reorientation. Additionally or alternatively, the computing system 102 may instruct the application system 40 to alter a pressure and/or droplet size of agricultural product dispensed from the nozzle assembly 48 based on the second angle θ. In various cases, the computing system 102 may utilize a look-up table(s), suitable mathematical formula, and/or algorithms stored within its memory device 104 that correlate the received sensing system data to a defined pressure and/or droplet size. It will be appreciated that some spray conditions, such as boom height and wind speed, may create an upper limit that limits the second angle θ magnitude and still allow for adequate spray distribution. Each of the maximum and/or minimum limits may be defined by an operator, predefined, and/or determined by the computing system 102 through one or more algorithms.

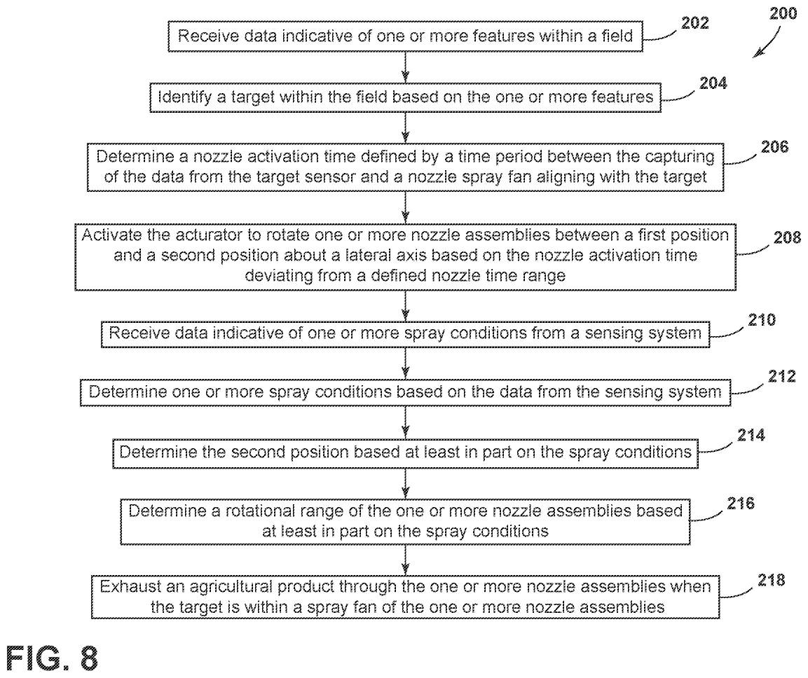

Referring now to FIG. 8, a flow diagram of some embodiments of a method 200 for an agricultural application operation is illustrated in accordance with aspects of the present subject matter. In general, the method 200 will be described herein with reference to the work vehicle 10 and the system 100 described above with reference to FIGS. 1-7. However, the disclosed method 200 may generally be utilized with any suitable agricultural work vehicle 10 and/or may be utilized in connection with a system having any other suitable system configuration. In addition, although FIG. 8 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 8, at (202), the method 200 can include receiving data indicative of one or more features within a field from a target sensor. The target sensor may be configured to capture data indicative of various features within a field. In several embodiments, the target sensor may be installed or otherwise positioned on one or more boom sections of the boom assembly and/or any other practicable location about the vehicle.

At (204), the method 200 can include identifying a target within the field based on the one or more features of a computing system. In this regard, the computing system may include any suitable image processing algorithms stored within its memory or may otherwise use any suitable image processing techniques to determine, for example, the presence of a target within the field based on the feature data. For instance, in some embodiments, the computing system may be able to distinguish between weeds and emerging/standing crops.

At (206), the method 200 can include determining a nozzle activation time defined by a period between the capturing of the data from the target sensor and a nozzle spray fan aligning with the target with the computing system. At (208), the method 200 can include activating the actuator to rotate one or more nozzle assemblies between a first position and a second position about an axis of rotation based on the nozzle activation time deviating from a defined nozzle time range. In various examples, the defined nozzle time range may be determined based on one or more inputs, one or more spray conditions, a position of the one or more nozzle assemblies, and/or a processing time between the computing system identifying a target and the spray axis of the nozzle aligning with the target when in the default position. In some cases, the one or more nozzle assemblies may be fluidly coupled with a header. In such cases, the actuator may be configured to rotate the header to rotate the one or more nozzle assemblies between the first position and the second position.

At (210), the method 200 can include receiving data indicative of one or more spray conditions from a sensing system. During a spray operation, various spray conditions may affect a spray quality of application of the agricultural product. To monitor such spray conditions, a sensing system may include one or more condition sensors, a weather station, and/or any other assembly, which may be installed on the vehicle and/or the boom assembly. In general, the sensing system may be configured to capture data indicative of one or more spray conditions associated with the fans of the agricultural product being dispensed by the nozzle assemblies. The spray conditions may, in turn, be indicative of the quality of the spray operation, such as whether the agricultural product is directed to the defined target.

At (212), the method 200 can include determining one or more spray conditions based on the data from the sensing system with the computing system. At (214), the method 200 can include determining the second position based at least in part on the spray conditions with the computing system.

At (216), the method can include determining a rotational range of the one or more nozzle assemblies based at least in part on the spray conditions with the computing system. The rotational range may be an angular limit about the axis of rotation of rotation of the nozzle assemblies relative to a vertical axis in both a direction vehicle forward of the vertical axis and vehicle rearward of the vertical axis. In some examples, the rotational range may be at least partially based on a height of the nozzle assembly relative to the field.

At (218), the method can include exhausting an agricultural product through the one or more nozzle assemblies when the target is within a spray fan of the one or more nozzle assemblies, which may include the detected/identified weeds (e.g., with a suitable herbicide) and/or the detected/identified crops (e.g., with a nutrient).

In various examples, the method 200 may implement machine learning methods and algorithms that utilize one or several vehicle learning techniques including, for example, decision tree learning, including, for example, random forest or conditional inference trees methods, neural networks, support vector machines, clustering, and Bayesian networks. These algorithms can include computer-executable code that can be retrieved by the computing system and/or through a network/cloud and may be used to evaluate and update the boom deflection model. In some instances, the vehicle learning engine may allow for changes to the boom deflection model to be performed without human intervention.

It is to be understood that the steps of any method disclosed herein may be performed by a computing system upon loading and executing software code or instructions which are tangibly stored on a tangible computer-readable medium, such as on a magnetic medium, e.g., a computer hard drive, an optical medium, e.g., an optical disc, solid-state memory, e.g., flash memory, or other storage media known in the art. Thus, any of the functionality performed by the computing system described herein, such as any of the disclosed methods, may be implemented in software code or instructions which are tangibly stored on a tangible computer-readable medium. The computing system loads the software code or instructions via a direct interface with the computer-readable medium or via a wired and/or wireless network. Upon loading and executing such software code or instructions by the controller, the computing system may perform any of the functionality of the computing system described herein, including any steps of the disclosed methods.

The term “software code” or “code” used herein refers to any instructions or set of instructions that influence the operation of a computer or controller. They may exist in a computer-executable form, such as vehicle code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. An agricultural system comprising:
a product application system comprising:
one or more nozzle assemblies; and
an actuator configured to move the one or more nozzle assemblies between a first position and a second position:
a target sensor configured to capture data indicative of one or more features within a field; and
a computing system communicatively coupled to the product application system and the target sensor, the computing system being configured to:
identify a target within the field based on the data from the target sensor;
determine a nozzle activation time defined by a period between capturing of the data from the target sensor and a nozzle spray fan aligning with the target; and
activate the actuator to move the one or more nozzle assemblies between the first position and the second position based on the nozzle activation time deviating from a defined nozzle time range.

2. The system of claim 1, further comprising:
a sensing system configured to capture data indicative of one or more spray conditions.

3. The system of claim 2, wherein the nozzle activation time is based at least partially on one or more spray conditions.

4. The system of claim 3, wherein the spray conditions can include at least one of an airflow at the one or more nozzle assemblies, an agricultural product application rate, an agricultural product pressure within a header, a vehicle speed, or a turning speed.

5. The system of claim 1, wherein the actuator is configured to rotate the nozzle assemblies from a first angle relative to the field to a second angle relative to the field.

6. The system of claim 5, wherein a focal axis of the target sensor is separated from a spray axis of the one or more nozzle assemblies by a first distance when in the first position, and wherein the focal axis of the target sensor is separated from the spray axis of the one or more nozzle assemblies by a second distance in the second position, the second distance being greater than the first distance.

7. The system of claim 1, wherein the nozzle activation time is at least partially based on a processing time of the computing system.

8. The system of claim 1, wherein the one or more nozzle assemblies are fluidly coupled with a header, and wherein the actuator rotates the header to move the one or more nozzle assemblies between the first position and the second position.

9. The system of claim 1, wherein the actuator is configured to rotate the one or more nozzle assemblies within a rotational range, and wherein the rotational range is at least partially based on a height of the nozzle assembly relative to the field.

10. A method for an agricultural application operation, the method comprising:
receiving, from a target sensor, data indicative of one or more features within a field;
identifying, with a computing a system, a target within the field based on the one or more features;
determining, a nozzle activation time defined by a period between capturing of the data from the target sensor and a nozzle spray fan aligning with the target; and
activating an actuator to rotate one or more nozzle assemblies between a first position and a second position about an axis of rotation based on the nozzle activation time deviating from a defined nozzle time range.

11. The method of claim 10, further comprising:
exhausting an agricultural product through the one or more nozzle assemblies when the target is within a spray fan of the one or more nozzle assemblies.

12. The method of claim 10, wherein the one or more nozzle assemblies are fluidly coupled with a header, and wherein the actuator is configured to rotate the header to rotate the one or more nozzle assemblies between the first position and the second position.

13. The method of claim 10, further comprising:
receiving, from a sensing system, data indicative of one or more spray conditions; and
determining, with the computing system, the one or more spray conditions based on the data from the sensing system.

14. The method of claim 13, further comprising:
determining, with the computing system, the second position based at least in part on the spray conditions.

15. The method of claim 14, further comprising:
determining, with the computing system, a rotational range of the one or more nozzle assemblies based at least in part on the spray conditions.

16. An agricultural system comprising:
a product application system comprising:
one or more nozzle assemblies; and
an actuator configured to move the one or more nozzle assemblies between a first position and a second position;
a sensing system configured to capture data indicative of one or more spray conditions;
a target sensor configured to capture data indicative of one or more features within a field; and
a computing system communicatively coupled to the product application system, the target sensor, and the sensing system, the computing system being configured to:
identify a target within the field based on the data from the target sensor; and
determine a nozzle activation time defined by a period between the capturing of the data from the target sensor and a nozzle spray fan aligning with the target based on the data from the sensing system.

17. The agricultural system of claim 16, wherein the computing system is further configured to:
activate the actuator to move the one or more nozzle assemblies between the first position and the second position based on the nozzle activation time deviating from a defined nozzle time range.

18. The system of claim 16, wherein the one or more nozzle assemblies are fluidly coupled with a header, and wherein the actuator rotates the header to move the one or more nozzle assemblies between the first position and the second position.

19. The system of claim 16, wherein the second position is vehicle rearward of a vertical axis defined between the one or more nozzle assemblies and the field.

20. The agricultural system of claim 16, wherein the actuator is configured to rotate the one or more nozzle assemblies within a rotational range, and wherein the rotational range is at least partially based on a height of the nozzle assembly relative to the field.
